(19) United States
(12) Patent Application Publication
(10) Pub. No.: US 2023/0105707 A1
(43) Pub. Date: Apr. 6, 2023

(54) Radiation-Curable Ink Jet Composition

(71) Applicant: SEIKO EPSON CORPORATION, Tokyo (JP)

(72) Inventors: Toru SAITO, Yamagata (JP); Toshiyuki YODA, Matsumoto (JP); Kyohei TANAKA, Sagamihara (JP); Midori SEKINE, Matsumoto (JP)

(21) Appl. No.: 17/950,159

(22) Filed: Sep. 22, 2022

(30) Foreign Application Priority Data
Sep. 27, 2021 (JP) 2021-156411

(51) Int. Cl. C09D 11/107; C09D 11/32

(52) U.S. Cl. CPC C09D 11/107; C09D 11/32

(57) ABSTRACT

A radiation-curable ink jet composition includes a polyfunctional monomer containing a predetermined acrylic compound, and a monofunctional monomer containing vinyl methyl oxazolidinone.

The present application is based on, and claims priority from JP Application Serial Number 2021-156411, filed Sep. 27, 2021, the disclosure of which is hereby incorporated by reference herein in its entirety.

### BACKGROUND

### 1. Technical Field

The present disclosure relates to a radiation-curable ink jet composition.

### 2. Related Art

An ink jet recording method enables recording of high-definition images using relatively simple devices, and thus rapid development has been made in various fields. Under such circumstances, various research has been conducted on curability and the like of a coating film of an ink jet composition to be cured by being irradiated with radiation. For example, JP-A-2013-091788 discloses an ink jet curable composition containing an allyloxymethyl group-containing acrylate for the purpose of providing an ink jet curable composition with a low viscosity, excellent jettability, and various excellent resistances such as heat resistance and plating resistance, a cured product thereof, and an electronic circuit board formed of the ink jet curable composition.

As described in JP-A-2013-091788, an acrylic compound containing an allyloxymethyl group has advantages of a low viscosity, excellent resistance, and the like. However, it was found that the adhesiveness of a coating film formed of the radiation-curable ink jet composition containing the compound described above is not sufficient.

### SUMMARY

According to an aspect of the present disclosure, there is provided a radiation-curable ink jet composition including a polyfunctional monomer containing an acrylic compound represented by Formula (1), and a monofunctional monomer containing vinyl methyl oxazolidinone.

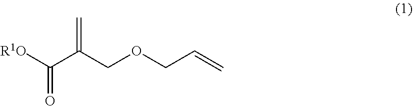

(In the formula, R¹ represents a hydrogen atom or a monovalent hydrocarbon group which may have an ether bond, and a hydrogen atom of the hydrocarbon group may be substituted with a halogen atom.)

### DESCRIPTION OF EXEMPLARY EMBODIMENTS

Hereinafter, embodiments of the present disclosure (hereinafter, referred to as “present embodiment”) will be described in detail, but the present disclosure is not limited thereto, and various modifications can be made within a range not departing from the scope of the present disclosure.

In the present specification, the term “(meth)acrylate” denotes at least one of acrylate or methacrylate corresponding to the acrylate, and the term “(meth)acryl” denotes at least one of acryl or methacryl corresponding to the acryl.

### 1. Radiation-Curable Ink Jet Composition

A radiation-curable ink jet composition according to the present embodiment (hereinafter, also simply referred to as “ink composition”) contains a polyfunctional monomer containing an acrylic compound represented by Formula (1), and a monofunctional monomer containing vinyl methyl oxazolidinone.

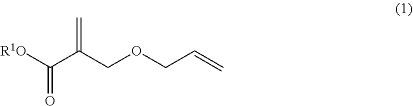

(In the formula, R¹ represents a hydrogen atom or a monovalent hydrocarbon group which may have an ether bond, and a hydrogen atom of the hydrocarbon group may be substituted with a halogen atom.)

Since the acrylic compound represented by Formula (1) typically has a low viscosity, dilution properties thereof are enhanced, and thus the acrylic compound can be used by being mixed with various ink compositions. Meanwhile, the acrylic compound represented by Formula (1) (hereinafter, also referred to as “allyloxymethyl group-containing acrylate”) is subjected to cyclic polymerization to obtain a linear polymer having a ring structure in the main chain, but it was found that the adhesiveness of a coating film to be obtained is not sufficient in a case where the composition only contains the monomer.

On the contrary, in the present embodiment, both the low viscosity and the adhesiveness can be achieved by using an allyloxymethyl group-containing acrylate and vinyl methyl oxazolidinone in combination.

The radiation-curable ink jet composition according to the present embodiment is cured by being irradiated with radiation. The radiation is not particularly limited, and examples thereof include ultraviolet rays, electron beams, infrared rays, visible light, X-rays, and active energy rays. Among these, from the viewpoint that radiation sources are available and widely used and that materials suitable for being cured by irradiation with ultraviolet rays are also available and widely used, ultraviolet rays are preferable as the radiation.

Further, the radiation-curable ink jet composition according to the present embodiment is a composition used by being jetted from an ink jet head using an ink jet method. Hereinafter, components that can be contained in the radiation-curable ink jet composition as an embodiment of the radiation-curable ink jet composition and a production method thereof will be described, but the composition according to the present embodiment may be a composition other than the ink composition, for example, a composition used for 3D molding.

### 1.1. Polymerizable Compound

In the present embodiment, compounds cured by being irradiated with radiation are collectively referred to as a polymerizable compound. The polymerizable compound contains a monofunctional monomer containing one polymerizable functional group and a polyfunctional monomer containing a plurality of polymerizable functional groups, and may contain an oligomer containing one or a plurality of polymerizable functional groups as necessary. Each polymerizable compound may be used alone or in combination of two or more kinds thereof.

The ink composition according to the present embodiment contains a polyfunctional monomer containing the allyloxymethyl group-containing acrylate and a monofunctional monomer containing the vinyl methyl oxazolidinone as the polymerizable compound, and may contain other polymerizable compounds as necessary. Other polymerizable compounds are not particularly limited, and examples thereof include monofunctional monomers other than the vinyl methyl oxazolidinone, polyfunctional monomers other than the allyloxymethyl group-containing acrylate, and oligomers such as a urethane oligomer.

### 1.1.1. Monofunctional Monomer

The ink composition according to the present embodiment contains vinyl methyl oxazolidinone as the monofunctional monomer and may contain other monofunctional monomers as necessary. Other monofunctional monomers are not particularly limited, and examples thereof include an aromatic monofunctional monomer and an aliphatic group-containing monofunctional monomer. Further, the ink composition may contain monofunctional monomers other than those described above, as necessary.

The content of the monofunctional monomer is not particularly limited, but is, for example, 1% by mass or greater and 80% by mass or less with respect to the total amount of the ink composition. From the viewpoint of effectively and reliably exhibiting the effects of the present disclosure, the content of the monofunctional monomer is preferably 5% by mass or greater and 70% by mass or less, more preferably 10% by mass or greater and 60% by mass or less, still more preferably 15% by mass or greater and 50% by mass or less, and even still more preferably 25% by mass or greater and 45% by mass or less with respect to the total amount of the ink composition.

### 1.1.1.1. Vinyl Methyl Oxazolidinone

Since the ink composition contains vinyl methyl oxazolidinone, the viscosity of the ink composition is likely to be decreased and the adhesiveness of the ink coating film is likely to be further improved. It is considered that since the vinyl methyl oxazolidinone has a viscosity lower than the viscosity of other N-vinyl compounds, the viscosity of the ink composition is unlikely to be increased and the adhesiveness of the coating film is improved.

The vinyl methyl oxazolidinone in the present embodiment denotes a compound represented by the following chemical formula.

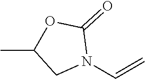

The content of the vinyl methyl oxazolidinone is not particularly limited, but is, for example, 1% by mass or greater and 60% by mass or less with respect to the total amount of the ink composition. From the viewpoint of further improving the adhesiveness of the ink coating film while decreasing the viscosity of the ink composition, the content of the vinyl methyl oxazolidinone is preferably 2% by mass or greater and 55% by mass or less, more preferably 3% by mass or greater and 50% by mass or less, still more preferably 5% by mass or greater and 40% by mass or less, and even still more preferably 10% by mass or greater and 30% by mass or less with respect to the total amount of the ink composition.

### 1.1.1.2. Other Monofunctional Monomers

Monofunctional monomers other than the vinyl methyl oxazolidinone are not particularly limited, and examples thereof include an aromatic monofunctional monomer and a monofunctional monomer containing a polycyclic hydrocarbon group. The curability of the ink composition, the rub resistance of the coating film, and the stretchability of the coating film are likely to be further improved by using such monomers.

### 1.1.1.2.1. Aromatic Monofunctional Monomer

The aromatic monofunctional monomer is not particularly limited, and examples thereof include phenoxyethyl (meth)acrylate, benzyl (meth)acrylate, alkoxylated 2-phenoxyethyl (meth)acrylate, ethoxylated nonylphenyl (meth)acrylate, alkoxylated nonylphenyl (meth)acrylate, p-cumylphenol EO-modified (meth)acrylate, and 2-hydroxy-3-phenoxypropyl (meth)acrylate.

In the ink composition according to the present embodiment, it is preferable that the monofunctional monomer contain a monofunctional (meth)acrylate having an aromatic ring structure. The solubility of a photopolymerization initiator is likely to be improved and the curability of the ink composition is likely to be further improved by allowing the monofunctional monomer to contain a monofunctional (meth)acrylate having an aromatic ring structure.

Among the examples of the aromatic monofunctional monomer, phenoxyethyl (meth)acrylate (PEA) and benzyl (meth)acrylate (BZA) are preferable. The solubility of the photopolymerization initiator is likely to be improved and the curability of the ink composition is likely to be further improved by using such an aromatic monofunctional monomer.

The content of the aromatic monofunctional monomer is not particularly limited, but is, for example, 1% by mass or greater and 30% by mass or less with respect to the total amount of the ink composition. From the viewpoint of further improving the curability of the ink composition, the content of the aromatic monofunctional monomer is preferably 2% by mass or greater and 25% by mass or less, more preferably 3% by mass or greater and 20% by mass or less, and still more preferably 5% by mass or greater and 15% by mass or less with respect to the total amount of the ink composition.

### 1.1.1.2.2. Aliphatic Group-Containing Monofunctional Monomer

The aliphatic group-containing monofunctional monomer is not particularly limited, and examples thereof include an aliphatic group-containing (meth)acrylate such as 3,3,5-trimethylcyclohexyl (meth)acrylate, isobornyl (meth)acrylate, tert-butylcyclohexanol (meth)acrylate, or 2-(meth)acrylic acid-1,4-dioxaspiro[4,5]dec-2-ylmethyl, a linear or branched aliphatic group-containing (meth)acrylate such as isoamyl (meth)acrylate, stearyl (meth)acrylate, lauryl (meth)acrylate, octyl (meth)acrylate, decyl (meth)acrylate, isodecyl (meth)acrylate, isomyristyl (meth)acrylate, isostearyl (meth)acrylate, 2-hydroxybutyl (meth)acrylate, butoxyethyl (meth)acrylate, tetrahydrofurfuryl (meth)acrylate, 2-hydroxyethyl (meth)acrylate, or 2-hydroxypropyl (meth)acrylate, and lactone-modified plastic (meth)acrylate.

Among the examples of the aliphatic group-containing monofunctional monomer, isobornyl acrylate (IBXA) is preferable. The curability and the rub resistance of the ink composition are likely to be further improved by using such an aliphatic group-containing monofunctional monomer.

The content of the aliphatic group-containing monofunctional monomer is not particularly limited, but is, for example, 1% by mass or greater and 40% by mass or less with respect to the total amount of the ink composition. From the viewpoint of further improving the curability and the rub resistance of the ink composition, the content of the aliphatic group-containing monofunctional monomer is preferably 3% by mass or greater and 30% by mass or less, more preferably 5% by mass or greater and 20% by mass or less, and still more preferably 8% by mass or greater and 15% by mass or less.

### 1.1.2. Polyfunctional Monomer

The ink composition according to the present embodiment contains an allyloxymethyl group-containing acrylate as the polyfunctional monomer and may contain other polyfunctional monomers as necessary. Other polyfunctional monomers are not particularly limited, and examples thereof include a vinyl ether group-containing (meth)acrylate and a bifunctional (meth)acrylate.

The content of the polyfunctional monomer is preferably 15% by mass or greater and 80% by mass or less, more preferably 20% by mass or greater and 75% by mass or less, still more preferably 25% by mass or greater and 70% by mass or less, even still more preferably 30% by mass or greater and 65% by mass or less, and even still more preferably 35% by mass or greater and 60% by mass or less with respect to the total amount of the ink composition.

### 1.1.2.1. Allyloxymethyl Group-Containing Acrylate

The allyloxymethyl group-containing acrylate is a polyfunctional monomer in terms of the chemical formula, as represented by Formula (1), but a linear polymer having a ring structure in the main chain is obtained by performing cyclic polymerization on the allyloxymethyl group-containing acrylate, as described above. Therefore, the allyloxymethyl group-containing acrylate can be said to be similar to a monofunctional monomer that provides a linear polymer after polymerization.

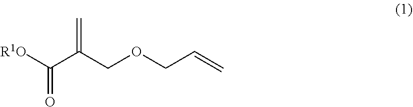

(In the formula, R¹ represents a hydrogen atom or a monovalent hydrocarbon group which may have an ether bond, and a hydrogen atom of the hydrocarbon group may be substituted with a halogen atom.)

In Formula (1), the hydrocarbon group is not particularly limited, and examples thereof include a chain saturated hydrocarbon group having 1 or more carbon atoms, a chain unsaturated hydrocarbon group having 3 or more carbon atoms, an alicyclic hydrocarbon group having 3 or more carbon atoms, and an aromatic hydrocarbon group having 6 or more carbon atoms. Among these, a chain saturated hydrocarbon group having 1 to 30 carbon atoms, a chain unsaturated hydrocarbon group having 3 to 30 carbon atoms, an alicyclic hydrocarbon group having 4 to 30 carbon atoms, and an aromatic hydrocarbon group having 6 to 30 carbon atoms are preferable.

The halogen atom is not particularly limited, and examples thereof include a fluorine atom, a chlorine atom, a bromine atom, and an iodine atom.

The chain saturated hydrocarbon group is not particularly limited, and examples thereof include a methyl group, an ethyl group, an n-propyl group, an isopropyl group, an n-butyl group, a sec-butyl group, a tert-butyl group, an n-amyl group, a sec-amyl group, a tert-amyl group, a neopentyl group, an n-hexyl group, a sec-hexyl group, an n-heptyl group, an n-octyl group, a sec-octyl group, a tert-octyl group, a 2-ethylhexyl group, a caprylic group, a nonyl group, a decyl group, a undecyl group, a lauryl group, a tridecyl group, a myristyl group, a pentadecyl group, a cetyl group, a heptadecyl group, a stearyl group, a nonadecyl group, an eicosyl group, a ceryl group, and a mericyl group.

The chain unsaturated hydrocarbon group is not particularly limited, and examples thereof include a crotyl group, a 1,1-dimethyl-2-propenyl group, a 2-methyl-butenyl group, a 3-methyl-2-butenyl group, a 3-methyl-3-butenyl group, a 2-methyl-3-butenyl group, an oleyl group, a linoleic group, and a linolenic group.

The alicyclic hydrocarbon group is not particularly limited, and examples thereof include a cyclopentyl group, a cyclopentylmethyl group, a cyclohexyl group, a cyclohexylmethyl group, a 4-methylcyclohexyl group, a 4-tert-butylcyclohexyl group, a tricyclodecanyl group, an isobornyl group, an adamantyl group, a dicyclopentanyl group, and a dicylopentenyl group.

The aromatic hydrocarbon group is not particularly limited, and examples thereof include a phenyl group, a methylphenyl group, a dimethylphenyl group, a trimethylphenyl group, a 4-tert-butylphenyl group, a benzyl group, a diphenylmethyl group, a diphenylethyl group, a triphenylmethyl group, a cinnamyl group, a naphthyl group, and an anthranyl group.

The hydrocarbon group having an ether bond is not particularly limited, and examples thereof include a chain ether group such as a methoxyethyl group, a methoxyethoxyethyl group, a methoxyethoxyethoxyethyl group, a 3-methoxybutyl group, an ethoxyethyl group, or an ethoxyethoxyethyl group, a group formed by combining a chain ether group with an alicyclic hydrocarbon group such as a cyclopentoxyethyl group, a cyclohexyloxyethyl group, a cyclopentoxyethoxyethyl group, a cyclohexyloxyethoxyethyl group, or a dicyclopentenyloxyethyl group, a group formed by combining a chain ether group with an aromatic hydrocarbon group such as a phenoxyethyl group or a phenoxyethoxyethyl group, and a cyclic ether group such as a glycidyl group, a β-methylglycidyl group, a β-ethylglycidyl group, a 3,4-epoxycyclohexylmethyl group, a 2-oxetanemethyl group, a 3-methyl-3-oxetanemethyl group, a 3-ethyl-3-oxetanemethyl group, a tetrahydrofuranyl group, a tetrahydrofurfuryl group, a tetrahydropyranyl group, a dioxazolanyl group, or a dioxanyl group.

Examples of the above-described acrylic compound include methyl allyloxymethyl acrylate, ethyl allyloxymethyl acrylate, methoxyethyl allyloxymethyl acrylate, methoxyethoxyethyl allyloxymethyl acrylate, vinyl allyloxymethyl acrylate, fluoroethyl allyloxymethyl acrylate, and chloroethyl allyloxymethyl acrylate.

In the present embodiment, the content of the allyloxymethyl group-containing acrylate is not particularly limited, but is, for example, 3% by mass or greater and 70% by mass or less with respect to the total mass of the ink composition. From the viewpoint of further improving the balance between the viscosity and the adhesiveness in the ink composition, the content of the allyloxymethyl group-containing acrylate is preferably 5% by mass or greater and 65% by mass or less, more preferably 10% by mass or greater and 60% by mass or less, still more preferably 20% by mass or greater and 55% by mass or less, and even still more preferably 30% by mass or greater and 50% by mass or less with respect to the total amount of the ink composition.

In the present embodiment, the content of the polyfunctional monomer other than the allyloxymethyl group-containing acrylate is preferably 25% by mass or less with respect to the total amount of the polyfunctional monomer. The content of the polyfunctional monomer other than the allyloxymethyl group-containing acrylate is more preferably 3% by mass or greater and 20% by mass or less and still more preferably 5% by mass or greater and 15% by mass or less with respect to the total amount of the polyfunctional monomer. The viscosity of the ink composition is further decreased by setting the content of the polyfunctional monomer other than the allyloxymethyl group-containing acrylate to be in the above-described ranges.

In the present embodiment, the total content of the allyloxymethyl group-containing acrylate and the vinyl methyl oxazolidinone is preferably 40% by mass or greater with respect to the total amount of the ink composition. From the viewpoint of further decreasing the viscosity of the ink composition and further improving the adhesiveness, the total content of the allyloxymethyl group-containing acrylate and the vinyl methyl oxazolidinone is more preferably 45% by mass or greater and 85% by mass or less, still more preferably 50% by mass or greater and 75% by mass or less, and even still more preferably 50% by mass or greater and 65% by mass or less with respect to the total amount of the ink composition.

### 1.1.2.2. Vinyl Ether Group-Containing (Meth)Acrylate

The vinyl ether group-containing (meth)acrylate that can be contained in the ink composition according to the present embodiment is not particularly limited, and examples thereof include a compound represented by Formula (2). The viscosity of the ink composition is likely to decreased and the jetting stability is likely to be further improved by allowing the ink composition to contain such a vinyl ether group-containing (meth)acrylate. Further, the curability of the ink composition is improved, and thus the adhesiveness and the rub resistance of the coating film are likely to be further improved.

H₂C═CR²—CO—OR³—O—CH═CH—R⁴ (2)

(In the formula, R² represents a hydrogen atom or a methyl group, R³ represents a divalent organic residue having 2 to 20 carbon atoms, and R⁴ represents a hydrogen atom or a monovalent organic residue having 1 to 11 carbon atoms.)

In Formula (2), examples of the divalent organic residue having 2 to 20 carbon atoms as R² include a linear, branched, or cyclic alkylene group having 2 to 20 carbon atoms which may be substituted, an alkylene group having 2 to 20 carbon atoms which has an oxygen atom via an ether bond and/or an ester bond in the structure and may be substituted, and a divalent aromatic group having 6 to 11 carbon atoms which may be substituted. Among these, an alkylene group having 2 to 6 carbon atoms such as an ethylene group, an n-propylene group, an isopropylene group, or a butylene group and an alkylene group having 2 to 9 carbon atoms which has an oxygen atom via an ether bond such as an oxyethylene group, an oxy n-propylene group, an oxyisopropylene group, or an oxybutylene group in the structure are preferable. Further, from the viewpoint that the viscosity of the ink composition can be further decreased and the curability of the ink composition is made to be more satisfactory, a compound having a glycol ether chain, in which R² represents an alkylene group having 2 to 9 carbon atoms which has an oxygen atom via an ether bond such as an oxyethylene group, an oxy n-propylene group, an oxyisopropylene group, or an oxybutylene group in the structure, is more preferable.

In Formula (2), as the monovalent organic residue having 1 to 11 carbon atoms as R³, a linear, branched, or cyclic alkyl group having 1 to 10 carbon atoms which may be substituted or an aromatic group having 6 to 11 carbon atoms which may be substituted is suitable. Among these, an alkyl group having 1 or 2 carbon atoms which is a methyl group or an ethyl group or an aromatic group having 6 to 8 carbon atoms such as a phenyl group or a benzyl group is suitably used.

When the above-described organic residues are groups which may be substituted, the substituents thereof are classified into groups having carbon atoms and groups having no carbon atoms. First, when the substituent is a group having carbon atoms, the number of carbon atoms is counted as the number of carbon atoms of the organic residue. The groups having carbon atoms are not limited to the following examples, and examples thereof include a carboxyl group and an alkoxy group. Next, the groups having no carbon atoms are not limited to the following examples, and examples thereof include a hydroxyl group and a halo group.

The compound represented by Formula (2) is not particularly limited, and specific examples thereof include 2-(2-vinyloxyethoxy)ethyl acrylate (VEEA), 1-methyl-2-vinyloxypropyl (meth)acrylate, 2-vinyloxybutyl (meth)acrylate, 4-vinyloxycyclohexyl (meth)acrylate, 6-vinyloxyhexyl (meth)acrylate, 4-vinyloxymethylcyclohexylmethyl (meth)acrylate, 3-vinyloxymethylcylohexylmethyl (meth)acrylate, 2-vinyloxymethylcyclohexylmethyl (meth)acrylate, p-vinyloxymethylphenylmethyl (meth)acrylate, m-vinyloxymethylphenylmethyl (meth)acrylate, o-vinyloxymethylphenylmethyl (meth)acrylate, 2-(2-vinyloxyethoxy)ethyl methacrylate, 2-(vinyloxyisopropoxy)ethyl (meth)acrylate, 2-(vinyloxyethoxy)propyl (meth)acrylate, and 2-(vinyloxyethoxy)isopropyl (meth)acrylate. Among these specific examples, from the viewpoint of easily achieving the balance between the curability and the viscosity of the ink composition and the rub resistance of the coating film, 2-(2-vinyloxyethoxy)ethyl acrylate (VEEA) is preferable.

The content of the vinyl ether group-containing (meth)acrylate is not particularly limited, but is, for example, 0% by mass or greater and 60% by mass or less with respect to the total amount of the ink composition. From the viewpoint of easily achieving the balance between the curability and the viscosity of the ink composition and the rub resistance of the coating film, the content of the vinyl ether group-containing (meth)acrylate is preferably 1% by mass or greater and 40% by mass or less, more preferably 3% by mass or greater and 30% by mass or less, and still more preferably 5% by mass or greater and 25% by mass or less with respect to the total amount of the ink composition.

In the present embodiment, the total content of the allyloxymethyl group-containing acrylate, the vinyl methyl oxazolidinone, and the vinyl ether group-containing (meth)acrylate is preferably 50% by mass or greater with respect to the total amount of the ink composition. From the viewpoint of further decreasing the viscosity of the ink composition, further improving the jetting stability, and further improving the adhesiveness, the total content thereof is more preferably 55% by mass or greater and 90% by mass or less, still more preferably 65% by mass or greater and 85% by mass or less, and even still more preferably 70% by mass or greater and 85% by mass or less with respect to the total amount of the ink composition.

### 1.1.2.3. Bifunctional (Meth)Acrylate

In the present embodiment, the ink composition may contain a bifunctional (meth)acrylate. The bifunctional (meth)acrylate is not particularly limited, and examples thereof include dipropylene glycol diacrylate (DPGDA), diethylene glycol di(meth)acrylate, triethylene glycol di(meth)acrylate, tetraethylene glycol di(meth)acrylate, polyethylene glycol di(meth)acrylate, dipropylene glycol dimethacrylate, tripropylene glycol di(meth)acrylate (TPGDA), polypropylene glycol di(meth)acrylate, 1,4-butanediol di(meth)acrylate, 1,6-hexanediol di(meth)acrylate (HDDA), 1,9-nonanediol di(meth)acrylate, neopentyl glycol di(meth)acrylate, dimethylol-tricyclodecane di(meth)acrylate, ethylene oxide (EO) adduct di(meth)acrylate of bisphenol A, propylene oxide (PO) adduct di(meth)acrylate of bisphenol A, neopentyl glycol di(meth)acrylate hydroxypivalate, and polytetramethylene glycol di(meth)acrylate.

Among these, it is preferable that the ink composition contain dipropylene glycol diacrylate (DPGDA) and/or tripropylene glycol di(meth)acrylate (TPGDA) as the bifunctional (meth)acrylate.

The content of the bifunctional (meth)acrylate is not particularly limited, but is, for example, 0% by mass or greater and 20% by mass or less, preferably 2% by mass or greater and 15% by mass or less, and more preferably 3% by mass or greater and 10% by mass or less with respect to the total amount of the ink composition.

### 1.1.2.4. Other Polyfunctional Monomers

The ink composition according to the present embodiment may contain polyfunctional monomers other than the allyloxymethyl group-containing acrylate and the bifunctional (meth)acrylate. Examples of such polyfunctional monomers include trifunctional or higher polyfunctional (meth)acrylates such as trimethylolpropane tri(meth)acrylate, EO-modified trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, glycerin propoxy tri(meth)acrylate, caprolactone-modified trimethylolpropane tri(meth)acrylate, pentaerythritol ethoxy tetra(meth)acrylate, and caprolactam-modified dipentaerythritol hexa(meth)acrylate.

### 1.1.3. Oligomer

The ink composition according to the present embodiment may contain an oligomer. The oligomer is a multimer containing a polymerizable compound as a constituent component and denotes a compound containing one or a plurality of polymerizable functional groups. Further, the polymerizable compound here is not limited to the monofunctional monomer and the polyfunctional monomer described above. In the present embodiment, a compound having a molecular weight of 1000 or greater is defined as an oligomer and a compound having a molecular weight of 1000 or less is defined as a monomer.

Such an oligomer is not particularly limited, and examples thereof include a urethane acrylate oligomer having a repeating structure that is urethane, a polyester acrylate oligomer having a repeating structure that is an ester, and an epoxy acrylate oligomer having a repeating structure that is epoxy.

Among these, a urethane acrylate oligomer is preferable, an aliphatic urethane acrylate oligomer or an aromatic urethane acrylate oligomer is more preferable, and an aliphatic urethane acrylate oligomer is still more preferable. Further, the urethane acrylate oligomer is preferably a tetrafunctional or lower functional urethane acrylate oligomer and more preferably a bifunctional or lower functional urethane acrylate oligomer. The viscosity is likely to be further decreased and the curability and the adhesiveness are likely to be further improved by using such an oligomer.

The content of the oligomer is preferably in a range of 1.0% to 15% by mass, more preferably in a range of 1.0% to 10% by mass, and still more preferably in a range of 2.0% to 7.0% by mass with respect to the total amount of the ink composition. The viscosity is likely to be further decreased and the curability and the adhesiveness are likely to be further improved by setting the content of the oligomer with respect to the total amount of the ink composition to be in the above-described ranges.

### 1.2. Photopolymerization Initiator

The photopolymerization initiator that can be contained in the ink composition according to the present embodiment is not particularly limited as long as an active species is generated by irradiation with radiation, and examples thereof include known photopolymerization initiators such as an acylphosphine oxide-based photopolymerization initiator, an alkylphenone-based photopolymerization initiator, and a titanocene-based photopolymerization initiator. Among these, an acylphosphine oxide-based photopolymerization initiator is preferable. The curability of the ink composition is likely to be further improved, and particularly the curability obtained by performing the curing process with light of a UV-LED is likely to be further improved by using such a photopolymerization initiator. The photopolymerization initiator may be used alone or in a combination of two or more kinds thereof.

The acylphosphine oxide-based photopolymerization initiator is not particularly limited, and examples thereof include 2,4,6-trimethylbenzoyl diphenylphosphine oxide, bis(2,4,6-trimethylbenzoyl)-phenylphosphine oxide, and bis-(2,6-dimethoxybenzoyl)-2,4,4-trimethylpentyl phosphine oxide.

Examples of trade names of commercially available products of such an acylphosphine oxide-based photopolymerization initiator include Omnirad 819 (bis(2,4,6-trimethylbenzoyl)-phenylphosphine oxide), Omnirad TPO (2,4,6-trimethylbenzoyldiphenylphosphine oxide), Omnirad TPO-L (ethyl (2,4,6-trimethylbenzoyl)phenylphosphinate), IRGACURE 1800 (mixture of bis-(2,6-dimethoxybenzoyl)-2,4,4-trimethylpentylphosphine oxide and 1-hydroxy-cyclohexyl-phenyl ketone at mass ratio of 25:75), and IRGACURE TPO (2,4,6-trimethylbenzoyldiphenylphosphine oxide).

The content of the photopolymerization initiator is preferably in a range of 3.0% to 20% by mass, more preferably in a range of 5.0% to 18% by mass, and still more preferably in a range of 8.0% to 15% by mass with respect to the total amount of the ink composition. The curability of the ink composition and the solubility of the photopolymerization initiator are likely to be further improved by setting the content of the photopolymerization initiator to be in the above-described ranges.

### 1.3. Sensitizer

The ink composition according to the present embodiment may contain a sensitizer in addition to the above-described photopolymerization initiator. The sensitizer that can be contained in the ink composition is not particularly limited, and examples thereof include a compound having a thioxanthone skeleton and more specific examples thereof include a diester of carboxymethoxythioxanthone and polytetramethylene glycol. The curability is likely to be further improved by allowing the ink composition to contain the sensitizer.

Examples of trade names of commercially available products of the sensitizer include Speedcure DETX (2,4-diethylthioxanthone), Omnipol TX (diester of carboxymethoxythioxanthone and polytetramethylene glycol), and SpeedCure 7010 (thioxanthone-based sensitizer).

The content of the sensitizer is not particularly limited, but is, for example, 1.0% by mass or greater and 10% by mass or less with respect to the total amount of the ink composition. From the viewpoint of further improving the curability of the ink composition, the content thereof is preferably 1.5% by mass or greater and 5.0% by mass or less and more preferably 2.0% by mass or greater and 3.0% by mass or less.

### 1.4. Fluorescent Brightener

A fluorescent brightener that can be contained in the ink composition according to the present embodiment is not particularly limited, and examples thereof include a fluorescent brightener that absorbs light having a wavelength of approximately 300 to 450 nm and emits light having a wavelength of approximately 400 to 500 nm. Such a fluorescent brightener is not particularly limited, and examples thereof include naphthalene benzoxazolyl derivatives, thiophene benzoxazolyl derivatives, stilbene benzoxazolyl derivatives, coumarin derivatives, styrene biphenyl derivatives, pyrazolone derivatives, stilbene derivatives, styryl derivatives of benzene and biphenyl, and bis(benzazol-2-yl) derivatives. Further, these may be used alone or in combination of two or more kinds thereof.

Examples of commercially available products of the fluorescent brightener include TELALUX KCB and TELALUX OB.

The content of the fluorescent brightener is not particularly limited, but is, for example, in a range of 0.1% to 1% by mass with respect to the total amount of the ink composition. From the viewpoint of further improving the curability of the ink composition, the content of the fluorescent brightener is preferably in a range of 0.1% to 0.5% by mass.

### 1.5. Polymerization Inhibitor

The polymerization inhibitor that can be contained in the ink composition according to the present embodiment is not particularly limited, and examples thereof include p-methoxyphenol, hydroquinone monomethyl ether (MEHQ), 4-hydroxy-2,2,6,6-tetramethylpiperidine-N-oxyl (LA-7RD), a hindered amine compound, 2,2,6,6-tetramethylpiperidinyl-1-oxyl (TEMPO), hydroquinone, cresol, t-butylcatechol, 3,5-di-t-butyl-4-hydroxytoluene, 2,2′-methylenebis(4-methyl-6-t-butylphenol), 2,2′-methylenebis(4-ethyl-6-butylphenol), 4,4′-thiobis(3-methyl-6-t-butylphenol), and derivatives thereof. Among these, p-methoxyphenol, hydroquinone monomethyl ether (MEHQ), 4-hydroxy-2,2,6,6-tetramethylpiperidine-N-oxyl (LA-7RD), and derivatives thereof are preferable as the polymerization inhibitor. The storage stability of the ink composition at room temperature and at a low temperature is likely to be further improved by allowing the ink composition to contain such a polymerization inhibitor.

The content of the polymerization inhibitor is not particularly limited, but is, for example, in a range of 0.1% to 0.5% by mass. From the viewpoint of further improving the storage stability of the ink composition, the content of the polymerization inhibitor is preferably in a range of 0.1% to 0.3% by mass.

### 1.6. Surfactant

The ink composition may further contain a surfactant. The surfactant is not particularly limited, and examples thereof include an acetylene glycol-based surfactant, a fluorine-based surfactant, and a silicone-based surfactant.

The acetylene glycol-based surfactant is not particularly limited, and examples thereof include an alkylene oxide adduct of 2,4,7,9-tetramethyl-5-decyne-4,7-diol and 2,4,7,9-tetramethyl-5-decyne-4,7-diol and an alkylene oxide adduct of 2,4-dimethyl-5-decyne-4-ol and 2,4-dimethyl-5-decyne-4-ol.

The fluorine-based surfactant is not particularly limited, and examples thereof include perfluoroalkyl sulfonate, perfluoroalkyl carboxylate, perfluoroalkyl phosphoric acid ester, a perfluoroalkyl ethylene oxide adduct, perfluoroalkyl betaine, and a perfluoroalkylamine oxide compound.

Examples of the silicone-based surfactant include a polysiloxane-based compound, polyester-modified silicone, and polyether-modified organosiloxane. Examples of the polyester-modified silicone include BYK-347, BYK-348, BYK-UV3500, BYK-UV3510, and BYK-UV3530 (all manufactured by BYK Additives & Instruments), and examples of the polyether-modified silicone include BYK-3570 (manufactured by BYK Additives & Instruments).

The content of the surfactant is preferably in a range of 0.1% to 1% by mass and more preferably in a range of 0.2% to 0.8% by mass with respect to the total mass of the composition. The wettability of the composition is likely to be further improved by setting the content of the surfactant to be in the above-described ranges.

### 1.7. Coloring Material

The ink composition may further contain a coloring material. At least one of a pigment or a dye can be used as the coloring material.

The total content of the coloring material is preferably in a range of 0.2% to 20% by mass, more preferably in a range of 0.5% to 15% by mass, and still more preferably in a range of 1% to 10% by mass with respect to the total amount of the ink composition.

Both of an inorganic pigment and an organic pigment can also be used as the pigment. The pigment may be used alone or in combination of two or more kinds thereof.

Examples of the inorganic pigment include carbon blacks (C.I. (Colour Index Generic Name) Pigment Black 7) such as furnace black, lamp black, acetylene black, and channel black, iron oxide, and titanium oxide.

Examples of the organic pigment include an azo pigment such as an insoluble azo pigment, a condensed azo pigment, Azo Lake, or a chelate azo pigment, a polycyclic pigment such as a phthalocyanine pigment, a perylene pigment, a perinone pigment, an anthraquinone pigment, a quinacridone pigment, a dioxane pigment, a thioindigo pigment, an isoindolinone pigment, or a quinophthalone pigment, a chelate dye (such as a basic dye-type chelate or an acidic dye-type chelate), a lake dye (such as a basic dye-type lake or an acidic dye-type lake), a nitro pigment, a nitroso pigment, aniline black, and a daylight fluorescent pigment.

Further, the dye is not particularly limited, and an acidic dye, a direct dye, a reactive dye, or a basic dye can be used as the dye. The dye may be used alone or in combination of two or more kinds thereof.

### 1.8. Other Components

The radiation-curable ink jet composition according to the present embodiment may further contain additives such as a dispersant as necessary.

### 2. Method of Producing Ink Composition

The radiation-curable ink jet composition is produced (prepared) by mixing respective components and stirring the mixture such that the components are sufficiently uniformly mixed. In the present embodiment, it is preferable that the preparation of the ink composition include a step of performing at least one of an ultrasonic treatment or a heat treatment on a mixture obtained by mixing a polymerization initiator with at least some monomers in the process of the preparation. In this manner, the amount of dissolved oxygen in the prepared ink composition can be reduced, and thus an ink composition with excellent jetting stability and excellent storage stability can be obtained. A mixture containing at least the above-described components, a mixture further containing other components, or a mixture containing all the components that can be contained in the ink composition may be employed as the mixture. The monomers contained in the mixture may be at least some monomers that can be contained in the ink composition.

### 3. Recorded Material

A recorded material of the present embodiment is a material that is obtained by adhering the radiation-curable ink jet composition to a recording medium and curing the composition. In a case where the ink composition has satisfactory viscosity, adhesiveness, and stretchability, cracking or chipping of the coating film when post-processing such as cutting or bending is performed can be suppressed from occurring. Therefore, the recorded material of the present embodiment can be suitably used for sign applications and the like.

The material of the recording medium is not particularly limited, and examples thereof include plastics such as polyvinyl chloride, polyethylene terephthalate, polypropylene, polyethylene, polycarbonate, cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, and polyvinyl acetal and such plastics having surfaces that have been processed, glass, paper, metals, and wood.

### EXAMPLES

Hereinafter, the present disclosure will be described in more detail based on examples and comparative examples.

The present disclosure is not limited to the following examples.

### 1. Preparation of Radiation-Curable Ink Jet Composition

First, a part of a coloring material, a dispersant, and each monomer was weighed and added to a tank for pigment dispersion, a ceramic bead mill having a diameter of 1 mm was added to the tank, and the mixture was stirred, thereby obtaining a pigment dispersion liquid in which the coloring material had been dispersed in the monomer. Next, the remaining monomer, the polymerization initiator, and the polymerization inhibitor were added to a tank for a mixture which was a stainless steel container so that the composition listed in Table 1 was obtained, the mixture was mixed and stirred so as to be completely dissolved, the pigment dispersion liquid obtained in the above-described manner was poured into the mixture, and the solution was further mixed and stirred at room temperature for 1 hour and filtered through a membrane filter having a pore diameter of 5 μm, thereby obtaining a radiation-curable ink jet composition of each example. Further, the numerical value of each component shown in each example of the table is denoted in units of % by mass.

The abbreviations and components of the products listed in Table 1 are as follows.

### <Monofunctional Monomer>

VMOX (vinyl methyl oxazolidinone, manufactured by BASF SE)
PEA (phenoxyethyl acrylate, manufactured by Osaka Organic Chemical Industry Ltd.)
BZA (benzyl acrylate, manufactured by Osaka Organic Chemical Industry Ltd.)
IBXA (isobornyl acrylate, manufactured by Osaka Organic Chemical Industry Ltd.)
LA (lauryl acrylate, manufactured by Osaka Organic Chemical Industry Ltd.)

### <Polyfunctional Monomer>

AOMA (methyl 2-allyloxymethyl acrylate, manufactured by Nippon Shokubai Co., Ltd.)
VEEA (2-(2-vinyloxyethoxy)ethyl acrylate, manufactured by Nippon Shokubai Co., Ltd.)
DPGDA (dipropylene glycol diacrylate, manufactured by Sartomer)
TPGDA (tripropylene glycol diacrylate, manufactured by Osaka Organic Chemical Industry Ltd.)

### <Oligomer>

EC6081 (trade name, “ETERCURE 6081”, manufactured by Eternal Materials Co., Ltd., aliphatic urethane acrylate oligomer, number of functional groups: 1)
CN9893 (manufactured by Sartomer, polyester-based aliphatic urethane acrylate oligomer, number of functional groups: 2)

### <Photopolymerization Initiator>

Omnirad 819 (bis(2,4,6-trimethylbenzoyl)-phenylphosphine oxide, manufactured by IGM Resins B. V.)
Omnirad TPO (2,4,6-trimethylbenzoyldiphenylphosphine oxide, manufactured by IGM Resins B. V.)
Omnirad TPO-L (ethyl (2,4,6-trimethylbenzoyl)phenylphosphinate, manufactured by IGM Resins B. V.)

### <Sensitizer>

DETX (2,4-diethylthioxanthen-9-one, manufactured by LAMBSON Ltd.)

### <Fluorescent Brightener>

TELALUX KCB (1,4-bis(2-benzoxazolyl)naphthalene, manufactured by Clariant Japan K.K.)

### <Surfactant>

BYK-UV3500 (polyether-modified polydimethylsiloxane containing acryloyl group, manufactured by BYK Additives & Instruments)

### <Polymerization Inhibitor>

LA-7RD (4-hydroxy-2,2,6,6-tetramethylpeperidine-N-oxyl, manufactured by ADEKA Corporation)
MEHQ (hydroquinone monomethyl ether, manufactured by Kanto Chemical Co., Inc.)

### <Coloring Material>

Pigment Blue 15:3 (phthalocyanine blue, manufactured by DIC Corporation)
Solsperse 36000 (polymer dispersant, manufactured by Lubrizol Corporation)

### 2. Evaluation Method

### 2.1. Evaluation of Viscosity

The viscosity of each radiation-curable ink jet composition was measured in an environment of 20° C. using a rotational viscometer (product name, “Rheometer MCR-301”, manufactured by Anton Paar GmbH). The evaluation criteria are as follows.

### (Evaluation Criteria)

A: The viscosity was less than 5.0 mPa·s.
B: The viscosity was 5.0 mPa·s or greater and less than 10 mPa·s.
C: The viscosity was 10 mPa·s or greater and less than 15 mPa·s.
D: The viscosity was 15 mPa·s or greater.

### 2.2. Evaluation of Adhesiveness

A cured coating film was prepared on a polyvinyl chloride film in the same manner as the evaluation of the stretchability described below. The obtained coating film was evaluated by performing a cross-cut test in conformity with JIS K 5600-5-6.

More specifically, a blade of a cutting tool was applied perpendicularly to the coating film, and a grid of 10×10 cells was made such that the distance between cuts reached 1 mm. Transparent adhesive tape (width 25 mm) having a length of approximately 75 mm was attached to the grid, and the tape was sufficiently rubbed with a finger such that the cured film was transparent. Next, within 5 minutes after the tape had been attached, the tape was reliably peeled from the cured film at an angle of close to 60° in 0.5 to 1.0 seconds, and the state of the grid was visually observed. The evaluation criteria are as follows.

### (Evaluation Criteria)

A: Peeling of the cured film was observed in less than 10% of the grid.

B: Peeling of the cured film was observed in 10% or greater and less than 20% of the grid.

C: Peeling of the cured film was observed in 20% or greater and less than 35% of the grid.

D: Peeling of the cured film was observed in 35% or greater of the grid.

### 2.3. Evaluation of Stretchability

A polyvinyl chloride film (JT5829R, manufactured by MACtac) was coated with each radiation-curable ink jet composition using a bar coater such that the thickness of a coating film reached 10 μm. Next, the composition was cured with an energy of 400 mJ/cm² using a metal halide lamp (manufactured by Eye Graphics Co., Ltd.) to form a coating film. The release paper of the polyvinyl chloride film on which the coating film was formed was peeled off and cut into a strip shape with a width of 1 cm and a length of 8 cm to prepare test pieces. The elongation rate of each test piece was measured as the stretchability using a tension tester (TENSILON, manufactured by ORIENTEC, Co., Ltd.). The elongation rate was defined as a numerical value at the time point when cracks occurred in a case where the test piece was stretched at 5 mm/min. This numerical value was calculated by {length when cracking− length before elongation)/length before elongation×100}. The evaluation criteria are as follows.

### (Evaluation Criteria)

A: 300% or greater

B: 200% or greater and less than 300%

C: less than 200%

### 2.4. Evaluation of Rub Resistance

A polyvinyl chloride film (JT5829R, manufactured by MACtac) was coated with each radiation-curable ink jet composition using a bar coater such that the thickness of a coating film reached 10 μm. Next, the composition was cured with an energy of 400 mJ/cm² using a metal halide lamp (manufactured by Eye Graphics Co., Ltd.) to form a coating film. Thereafter, the rub resistance was evaluated using a Gakushin type Color Fastness Rubbing Tester (manufactured by TESTER SANGYO CO., LTD.) in conformity with JIS K 5701 (ISO 11628) (methods of testing inks, color developing samples, and printed matter used for lithographic printing are defined). Specifically, printed cotton fabric was placed on the surface of the coating film, rubbed the surface 50 times by applying a load of 500 g to the surface, and peeling of the cured surface of the recorded material after the rubbing was visually compared to the surface before being rubbed. The evaluation criteria are as follows.

### (Evaluation Criteria)

A: The printed cotton fabric was clean. The image surface was not peeled or scratched.

B: Stains were found on the printed cotton fabric. The image surface was not peeled or scratched.

C: Stains were found on the printed cotton fabric. The image surface was peeled or scratched.

TABLE 1

| | | Example | | | | | | | | | |
|---|---|---|---|---|---|---|---|---|---|---|---|
| | Product name | 1 | 2 | 3 | 4 | 5 | 6 | 7 | 8 | 9 | 10 |
| Monofunctional | VMOX | 30 | 25 | 25 | 20 | 20 | 20 | 15 | 15 | 15 | 15 |
| monomer | PEA | | | | | 10 | | 10 | 10 | 10 | 10 |
| | BZA | | | | | | 10 | | | | |
| | IBXA | | | | | | | 10 | | 10 | 10 |
| | LA | | | | | | | | 10 | | |
| Polyfunctional | AOMA | 51 | 56 | 46 | 41 | 41 | 41 | 36 | 36 | 36 | 36 |
| monomer | VEEA | 0 | 0 | 10 | 20 | 10 | 10 | 10 | 10 | 5 | 5 |
| | DPGDA | | | | | | | | | 5 | |
| | TPGDA | | | | | | | | | | 5 |
| Oligomer | EC6081 | | | | | | | | | | |
| | CN9893 | | | | | | | | | | |
| Photopolymerization | Omnirad 819 | 4.3 | 4.3 | 4.3 | 4.3 | 4.3 | 4.3 | 4.3 | 4.3 | 4.3 | 4.3 |
| initiator | Omnirad TPO | | | | | | | | | | |
| | Omnirad TPO-L | 7 | 7 | 7 | 7 | 7 | 7 | 7 | 7 | 7 | 7 |
| Sensitizer | DETX | 3 | 3 | 3 | 3 | 3 | 3 | 3 | 3 | 3 | 3 |
| Fluorescent | TELALUX KCB | | | | | | | | | | |
| brightener | | | | | | | | | | | |
| Surfactant | BYK-UV3500 | 0.5 | 0.5 | 0.5 | 0.5 | 0.5 | 0.5 | 0.5 | 0.5 | 0.5 | 0.5 |
| Polymerization | LA-7RD | 0.05 | 0.05 | 0.05 | 0.05 | 0.05 | 0.05 | 0.05 | 0.05 | 0.05 | 0.05 |
| inhibitor | MEHQ | 0.15 | 0.15 | 0.15 | 0.15 | 0.15 | 0.15 | 0.15 | 0.15 | 0.15 | 0.15 |
| Coloring material | Pigment Blue 15:3 | 2.5 | 2.5 | 2.5 | 2.5 | 2.5 | 2.5 | 2.5 | 2.5 | 2.5 | 2.5 |
| Dispersant | Solsperse 36000 | 1.5 | 1.5 | 1.5 | 1.5 | 1.5 | 1.5 | 1.5 | 1.5 | 1.5 | 1.5 |
| Total | | 100 | 100 | 100 | 100 | 100 | 100 | 100 | 100 | 100 | 100 |
| Evaluation item | Viscosity | A | A | A | A | A | A | A | A | A | A |
| | Adhesiveness | A | A | A | A | A | A | A | A | A | A |
| | Stretchability | A | A | A | A | A | A | A | A | A | A |
| | Rub resistance | B | B | A | A | A | A | A | B | A | A |

TABLE 2

| | | Example | | | | | | | | | |
|---|---|---|---|---|---|---|---|---|---|---|---|
| | Product name | 11 | 12 | 13 | 14 | 15 | 16 | 17 | 18 | 19 | 20 |
| Monofunctional | VMOX | 20 | 20 | 20 | 20 | 40 | 5.0 | 35 | 10 | 2.0 | 45 |
| monomer | PEA | 10.0 | 1.0 | 4.0 | 10.8 | 10.0 | | 15.0 | | 3.0 | 8.0 |
| | BZA | | | | | | | | | | |
| | IBXA | | | | | 10 | | 10 | | | 3.0 |
| | LA | | | | | | | | | | |
| Polyfunctional | AOMA | 41 | 46 | 46 | 41 | 10 | 60 | 6.0 | 66 | 60 | 10 |
| monomer | VEEA | 10 | 10 | 10 | 10 | 11 | 16 | 15 | 5.0 | 16 | 15 |
| | DPGDA | | | | | | | | | | |
| | TPGDA | | | | | | | | | | |
| Oligomer | EC6081 | | 4.0 | | | | | | | | |
| | CN9893 | | | 1.0 | | | | | | | |
| Photopolymerization | Omnirad 819 | 5.3 | 4.3 | 4.3 | 4.3 | 4.3 | 4.3 | 4.3 | 4.3 | 4.3 | 4.3 |
| initiator | Omnirad TPO | 6.0 | | | | | | | | | |
| | Omnirad TPO-L | | 7.0 | 7.0 | 7.0 | 7.0 | 7.0 | 7.0 | 7.0 | 7.0 | 7.0 |
| Sensitizer | DETX | 3.0 | 3.0 | 3.0 | 2.0 | 3.0 | 3.0 | 3.0 | 3.0 | 3.0 | 3.0 |
| Fluorescent | TELALUX KCB | | | | 0.20 | | | | | | |
| brightener | | | | | | | | | | | |
| Surfactant | BYK-UV3500 | 0.50 | 0.50 | 0.50 | 0.50 | 0.50 | 0.50 | 0.50 | 0.50 | 0.50 | 0.50 |
| Polymerizaton | LA-7RD | 0.05 | 0.05 | 0.05 | 0.05 | 0.05 | 0.05 | 0.05 | 0.05 | 0.05 | 0.05 |
| inhibitor | MEHQ | 0.15 | 0.15 | 0.15 | 0.15 | 0.15 | 0.15 | 0.15 | 0.15 | 0.15 | 0.15 |
| Coloring material | Pigment Blue 15:3 | 2.5 | 2.5 | 2.5 | 2.5 | 2.5 | 2.5 | 2.5 | 2.5 | 2.5 | 2.5 |
| Dispersant | Solsperse 36000 | 1.5 | 1.5 | 1.5 | 1.5 | 1.5 | 1.5 | 1.5 | 1.5 | 1.5 | 1.5 |
| Total | | 100 | 100 | 100 | 100 | 100 | 100 | 100 | 100 | 100 | 100 |
| Evaluation item | Viscosity | A | A | B | A | B | A | C | A | A | C |
| | Adhesiveness | A | A | A | A | A | B | A | B | C | A |
| | Stretchability | A | A | A | A | A | A | A | A | A | A |
| | Rub resistance | A | A | A | A | A | A | A | B | A | B |

TABLE 3

| | | Comparative Example | | | | |
|---|---|---|---|---|---|---|
| | Product name | 1 | 2 | 3 | 4 | 5 |
| Monofunctional | VMOX | 30 | | | | |
| monomer | PEA | 20 | 15 | 20 | 10 | 20 |
| | BZA | | | | | |
| | IBXA | 15 | 15 | 20 | 10 | |
| | LA | | | | | 40 |
| Polyfunctional | AOMA | | 35 | | | |
| monomer | VEEA | 6 | 6 | 21 | 56 | 16 |
| | DPGDA | 10 | 10 | 20 | 5 | 5 |
| | TPGDA | | | | | |
| Oligomer | EC6081 | | | | | |
| | CN9893 | | | | | |
| Photopolymerization | Omnirad 819 | 4.3 | 4.3 | 4.3 | 4.3 | 4.3 |
| initiator | Omnirad TPO | | | | | |
| | Omnirad TPO-L | 7 | 7 | 7 | 7 | 7 |
| Sensitizer | DETX | 3 | 3 | 3 | 3 | 3 |
| Fluorescent | TELALUX KCB | | | | | |
| brightener | | | | | | |
| Surfactant | BYK-UV3500 | 0.5 | 0.5 | 0.5 | 0.5 | 0.5 |
| Polymerization | LA-7RD | 0.05 | 0.05 | 0.05 | 0.05 | 0.05 |
| inhibitor | MEHQ | 0.15 | 0.15 | 0.15 | 0.15 | 0.15 |
| Coloring material | Pigment Blue 15:3 | 2.5 | 2.5 | 2.5 | 2.5 | 2.5 |
| Dispersant | Solsperse 36000 | 1.5 | 1.5 | 1.5 | 1.5 | 1.5 |
| Total | | 100 | 100 | 100 | 100 | 100 |
| Evaluation item | Viscosity | D | D | D | A | B |
| | Adhesiveness | B | C | D | D | C |
| | Stretchability | A | A | B | C | A |
| | Rub resistance | A | A | A | A | C |

### 3. Evaluation Results

It was found that the radiation-curable ink jet compositions containing the polyfunctional monomer containing an acrylic compound represented by Formula (1) and the monofunctional monomer containing vinyl methyl oxazolidinone in Examples 1 to 20 listed in Tables 1 and 2 were comprehensively highly evaluated in terms of the viscosity, the adhesiveness, the stretchability, and the rub resistance, a compared with comparative: compositions of Comparative Examples 1 to 5.

The radiation-curable ink jet composition of the present disclosure is industrially applicable.

What is claimed is:

1. A radiation-curable ink jet composition comprising:
a polyfunctional monomer containing an acrylic compound represented by Formula (1); and
a monofunctional monomer containing vinyl methyl oxazolidinone, 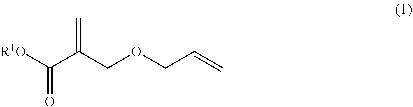
in the formula, R¹ represents a hydrogen atom or a monovalent hydrocarbon group which may have an ether bond, and a hydrogen atom of the hydrocarbon group may be substituted with a halogen atom.

2. The radiation-curable ink jet composition according to claim 1,
wherein a content of the polyfunctional monomer other than the acrylic compound is 25% by mass or less with respect to a total amount of the radiation-curable ink jet composition.

3. The radiation-curable ink jet composition according to claim 1,
wherein a total content of the acrylic compound and the vinyl methyl oxazolidinone is 40% by mass or greater with respect to a total amount of the radiation-curable ink jet composition.

4. The radiation-curable ink jet composition according to claim 1,
wherein the polyfunctional monomer contains a vinyl ether group-containing (meth)acrylate represented by Formula (2),
H₂C═CR²—CO—OR³—O—CH═CH—R⁴ (2)
in the formula, R² represents a hydrogen atom or a methyl group, R³ represents a divalent organic residue having 2 to 20 carbon atoms, and R⁴ represents a hydrogen atom or a monovalent organic residue having 1 to 11 carbon atoms.

5. The radiation-curable ink jet composition according to claim 4,
wherein a total content of the acrylic compound, the vinyl methyl oxazolidinone, and the vinyl ether group-containing (meth)acrylate is 50% by mass or greater with respect to a total amount of the radiation-curable ink jet composition.

6. The radiation-curable ink jet composition according t claim 1,
wherein the monofunctional monomer contains monofunctional (meth)acrylate having an aromatic ring structure.
